(19) United States
(12) Patent Application Publication
(10) Pub. No.: US 2022/0360459 A1
(43) Pub. Date: Nov. 10, 2022

(54) METHOD OF QUERYING DATA, METHOD OF WRITING DATA, ELECTRONIC DEVICE, AND READABLE STORAGE MEDIUM

(71) Applicant: Beijing Baidu Netcom Science Technology Co., Ltd., Beijing (CN)

(72) Inventor: Bo JING, Beijing (CN)

(21) Appl. No.: 17/872,911

(22) Filed: Jul. 25, 2022

(30) Foreign Application Priority Data
Aug. 2, 2021 (CN) 202110882583.5

(51) Int. Cl. H04L 9/00; H04L 9/08

(52) U.S. Cl. CPC H04L 9/50; H04L 9/0861; H04L 9/083

(57) ABSTRACT

A method of querying data, a method of writing data, an electronic device, and a readable storage medium are provided, which relate to a field of a computer technology, in particular to a field of a blockchain technology. The method includes: receiving a query request for target data stored in a blockchain, decrypting the target data in the TEE using a decryption key corresponding to an encryption key, and returning the decrypted target data.

### CROSS-REFERENCE TO RELATED APPLICATION(S)

This application claim, the benefit of Chinese Patent Application No. 202110882583.5 filed on Aug. 2, 2021, the whole disclosure of which is incorporated herein by reference.

### TECHNICAL FIELD

The present disclosure relates to a field of a computer technology, in particular to a field of a blockchain technology. Specifically, the present disclosure relates to a method of querying data, a method of writing data, an electronic device, and a readable storage medium.

### BACKGROUND

With a development of the blockchain technology, blockchain has been more and more widely used in various scenes. Due to characteristics of a decentralized operation, being difficult to tamper with and a high programmability, a smart contract has become an important part of a blockchain solution, and is widely used to solve a practical problem of a business party.

Data involved in the smart contract is stored in a ledger in plaintext. All nodes in the blockchain may view the data involved in the smart contract, so that some private data may not be processed through the smart contract, which affects an availability of the blockchain smart contract.

### SUMMARY

The present disclosure provides a method of querying data, a method of writing data, an electronic device, and a readable storage medium.

According to an aspect of the present disclosure, there is provided a method of querying data, including: receiving a query request for target data stored in a blockchain, wherein the target data is encrypted by an encryption key in a trusted execution environment TEE; and decrypting the target data In the TEE using a decryption key corresponding to the encryption key, and returning the decrypted target data.

According to another aspect of the present disclosure, there is provided a method of writing data, including: receiving a write request to write target data into a blockchain; and encrypting the target data in a TEE using an encryption key, and returning the encrypted target data.

According to another aspect of the present disclosure, there is provided an electronic device, including: at least one processor; and a memory communicatively connected to the at least one processor, wherein the memory stores instructions executable by the at least one processor, and the instructions, when executed by the at least one processor, cause the at least one processor to implement the method described above.

According to another aspect of the present disclosure, there is provided a non-transitory computer-readable storage medium having computer instructions stored thereon, wherein the computer instructions are configured to cause a computer to implement the method described above.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure.

FIG. 1 shows a schematic flowchart of a method of querying data provided by the embodiments of the present disclosure.

FIG. 2 shows a schematic flowchart of a method of writing data provided by the embodiments of the present disclosure.

FIG. 3 shows a schematic flowchart of a specific implementation provided by the embodiments of the present disclosure.

FIG. 4 shows a schematic structural diagram of an apparatus of querying data according to the embodiments of the present disclosure.

FIG. 5 shows a schematic structural diagram of an apparatus of writing data according to the embodiments of the present disclosure.

FIG. 6 shows a block diagram of an electronic device for implementing the method of the embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

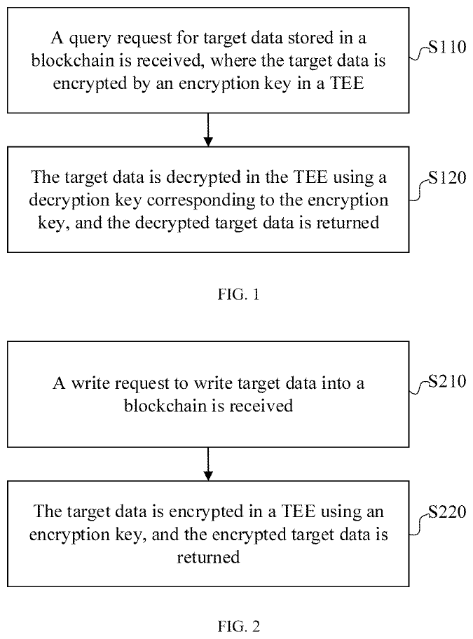

FIG. 1 shows a schematic flowchart of a method of querying data provided by the embodiments of the present disclosure. As shown in FIG. 1, the method may mainly include steps S110 to S120.

In step S110, a query request for target data stored in a blockchain is received, where the target data is encrypted by an encryption key in a trusted execution environment TEE.

The target data may be user's private data or sensitive data. In order to ensure a privacy of the target data, the target data may be encrypted and stored in a blockchain ledger. As an example, the target data may be stored in the form of a key-value pair (K-V).

In the embodiments of the present disclosure, an encrypted smart contract may be deployed to achieve a storage and logical processing of sensitive data.

The method provided by the embodiments of the present disclosure may be executed by an endorsement node. The endorsement node may pre-execute the smart contract to obtain an encrypted read-write set of the target data.

In the embodiments of the present disclosure, a TEE may be deployed in the endorsement node. The TEE may act as a black box, so that data processed in the TEE may not be known externally. The target data is encrypted in the TEE to ensure the privacy of the data. The encryption key used to encrypt the target data is generated and maintained in the TEE, so as to ensure a security of the encryption key and avoid the data security affected by a leakage of the key.

In the embodiments of the present disclosure, a user may initiate a query request for the target data through a light node in the blockchain, and a full node in communication with the light node broadcasts the query request in the blockchain, so that the endorsement node receives the query request.

In step S120, the target data is decrypted in the TEE using a decryption key corresponding to the encryption key, and the decrypted target data is returned.

In the embodiments of the present disclosure, the target data may be decrypted in the TEE using the decryption key corresponding to the encryption key to obtain the decrypted target data, and then the decrypted target data may be returned to the requester, so as to perform a query operation on the encrypted data.

The decryption key used to decrypt the target data is generated and maintained in the TEE, so as to ensure a security of the decryption key and avoid the data security affected by a leakage of the key.

In the method provided by the embodiments of the present disclosure, the query request for the target data encrypted and stored in the blockchain is received, the target data is decrypted in the TEE using the decryption key corresponding to the encryption key, and the decrypted target data is returned. Based on this solution, the query for the encrypted data stored in the blockchain may be achieved, so that a logical operation on the private data may be performed through the blockchain smert contract, and the availability of the blockchain smart contract may be improved.

In an optional embodiment of the present disclosure, the encryption key is generated based on a root key stored in the TEE and a data identification of the target data, and the decrypting the target data in the TEE using the decryption key corresponding to the encryption key may include: generating the decryption key corresponding to the encryption key based on the root key and the data identification of the target data using a virtual machine deployed in the TEE, and decrypting the target data based on the decryption key.

In the embodiments of the present disclosure, the root key used to generate the encryption key and the decryption key may be stored in a storage space in the TEE to ensure the security of the root key.

When encrypting and storing the target data, the encryption key may be generated based on the root key stored in the TEE and the data identification of the target data. Specifically, the encryption key may be generated by a key derivation algorithm.

When decrypting the encrypted target data, an operation of generating the decryption key may be performed in the virtual machine deployed in the TEE. Specifically, the decryption key may be reversely derived according to the key derivation algorithm based on the root key and the data identification of the target data.

In an optional embodiment of the present disclosure, the data identification may include: a first identification of a smart contract the target data belongs to, and a second identification of the encryption key.

In the embodiments of the present disclosure, a variety of business smart contracts may be deployed in the blockchain, and the business smart contract may be identified by the first identification. Specifically, the first identification may be a serial number of the business smart contract.

In the embodiments of the present disclosure, the encryption key may be identified by the second identification. Specifically, the second identification may be a serial number of the encryption key. Each time the encryption key is generated, one may be added to the serial number of the previous encryption key to generate the serial number of the newly generated encryption key.

In practice, the target data may further contain a version number of the target data, which is used to determine a correctness of the data version and ensure a consistency of the blockchain ledger. The version number may be automatically increased by one after each data update.

In an optional embodiment of the present disclosure, the decrypting the target data in the TEE using the decryption key corresponding to the encryption key may include: determining whether the query request satisfies a preset access condition; and decrypting the target data in the TEE using the decryption key corresponding to the encryption key, in response to the query request satisfying the preset access condition.

In the embodiments of the present disclosure, in order to ensure a validity of the query request, the access condition for the query request may be configured, and the authenticity and validity of the query request may be ensured by verifying whether the query request satisfies the access condition.

Allowing the access to the target data under the condition of ensuring the authenticity and validity of the query request may ensure the data security of the target data.

In an optional embodiment of the present disclosure, the access condition includes at least one of that a node initiating the query request has been authorized; or that a signature carried in the query request is verified.

In the embodiments of the present disclosure, in order to ensure the privacy of the target data a node may be authorized so that only the authorized node may access the data of the encrypted smart contract. Specifically, an address or a public key of the node may be authorized. A node identification of the authorized node may be written into an authorization list, so that whether the node initiating the query request has been authorized may be determined by determining whether the node is in the authorization list.

In the embodiments of the present disclosure, the access condition may further include that the carried signature is verified. Specifically, the query request may carry a signature of the node, and the signature may be verified to ensure the authenticity and validity of the query request.

In practice, it may be firstly determined whether the node initiating the query request has been authorized, and then the signature carried by the query request is verified.

FIG. 2 shows a schematic flowchart of a method of writing data provided by the embodiments of the present disclosure. As shown in FIG. 2, the method may mainly include steps S210 to S220.

In step S210, a write request to write target data into a blockchain is received.

The target data may be user's private data or sensitive data. In order to ensure a privacy of the target data, the target data may be encrypted and stored in a blockchain ledger. As an example, the target data may be in the form of key-value pair (K-V).

In the embodiments of the present disclosure, the user may initiate a write request for the target data through a light node in the blockchain, and a full node in cammunicstion with the light node broadcasts the write request in the blockchain, so that the endorsement node receives the write request.

In step S220, the target data is encrypted in a TEE using an encryption key, and the encrypted target data is returned.

In the embodiments of the present disclosure, an encrypted smart contract may be deployed to achieve a storage and logical processing of sensitive data.

The method provided by the embodiments of the present disclosure may be executed by an endorsement node. The endorsement node may pre-execute the smart contract to obtain an encrypted read-write set of the target data.

In the embodiments of the present disclosure, the TEE may be deployed in the endorsement node. The TEE may act as a black box, so that data processed in the TEE may not be known externally. The target data is encrypted in the TEE to ensure the privacy of the data. The encryption key used to encrypt the target data is generated and maintained in the TEE, so as to ensure a security of the encryption key and avoid the data security affected by a leakage of the key.

In the embodiments of the present disclosure, the target data may be encrypted in the TEE using the encryption key to obtain the encrypted target data, and then the encrypted target data may be returned to the requester. After receiving the encrypted target data returned by the endorsement node, the requester may write the encrypted data into the blockchain ledger to complete the writing operation of the target data.

In the method provided by the embodiments of the present disclosure, the write request to write the target data into the blockchain is received, the target data is encrypted in the TEE using the encryption key, and the encrypted target data is returned. Based on this solution, the writing of the encrypted data stored in the blockchain may be achieved, so the a logical operation on the private data may be performed through the blockchain smart contract, and the availability of the blockchain smart contract may be improved.

In an optional embodiment of the present disclosure, the encrypting the target data in the TEE using the encryption key may include: generating the encryption key based on a root key stored in the TEE and a data identification of the target data using a virtual machine deployed in the TEE, and encrypting the target data based on the encryption key.

In the embodiments of the present disclosure, the root key used to generate the encryption key may be stored in a storage space in the TEE to ensure the security of the root key.

In the embodiments of the present disclosure, when encrypting and storing the target data, the encryption key may be generated based on the root key stored in the TEE and the data identification of the target data using the virtual machine deployed in the TEE. Specifically, the encryption key may be generated by a key derivation algorithm.

In an optional embodiment of the present disclosure, the data identification may include: a first identification of a smart contract the target data belongs to, and a second identification of the encryption key.

In the embodiment of the present disclosure, a variety of business smart contracts may be deployed in the blockchain, and the business smart contract may be identified by the first identification. Specifically, the first identification may be a serial number of the business smart contract.

In the embodiments of the present disclosure, the encryption key may be identified by the second identification. Specifically, the second identification may be a serial number of the encryption key. Each time the encryption key is generated, one may be added to the serial number of the previous encryption key to generate the serial number of the newly generated encryption key.

In practice, the target data may further contain a version number of the target data, which is used to determine a correctness of the data version and ensure a consistency of the blockchain ledger. The version number may be automatically increased by one after each data update.

In an optional embodiment of the present disclosure, the encrypting the target data in the TEE using the encryption key may include: determining whether the write request satisfies a preset write condition; and encrypting the target data in the TEE using the encryption key, in response to the write request satisfying the preset write condition.

In the embodiments of the present disclosure, in order to ensure a validity of the write request, the write condition for the write request may be configured, and the authenticity and validity of the write request may be ensured by verifying whether the write request satisfies the write condition.

Allowing the writing of the target data under the condition of ensuring the authenticity and validity of the write request may ensure the validity of the written data.

In an optional embodiment of the present disclosure, the write condition includes at least one of that a node initiating the write request has been authorized; or a signature carried in the write request is verified.

In the embodiments of the present disclosure, in order to ensure the privacy of the target data, a node may be authorized so that only the authorized node may write data into the encrypted smart contract. Specifically, an address or a public key of the node may be authorized. A node identification of the authorized node may be written into an authorization list, so that whether the node initiating the write request has been authorized may be determined by determining whether the node is in the authorization list.

In practice, it may be firstly determined whether the node initiating the write request has been authorized, and then the signature carried by the write request is verified.

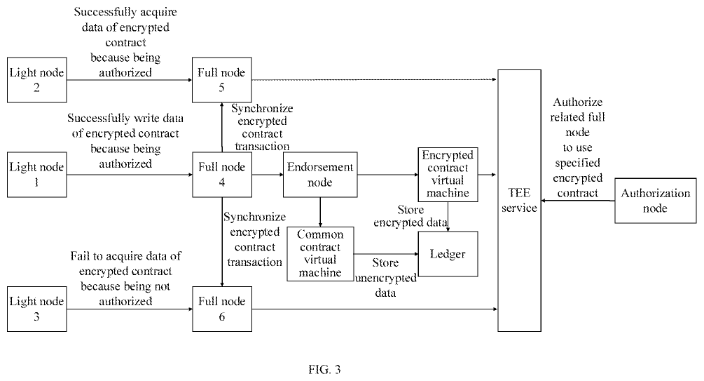

As an example, FIG. 3 shows a flowchart of a specific implementation of the present disclosure. As shown in FIG. 3, a communication connection is established between a light node 1 and a full node 4. The light node 1 initiates a write request that carries data to be written into an encrypted contract (i.e., the encrypted smart contract), and the full node 4 broadcasts the write request in the blockchain, so that the endorsement node receives the write request, and a TEE service is called through a virtual machine of the encrypted contract (that is, the target data is encrypted by the virtual machine deployed in the TEE). The encrypted target data may be stored in the ledger.

A communication connection is established between a light node 2 and a full node 5. The light node 2 initiates a query request, and the full node 5 broadcasts the query request in the blockchain, so that the endorsement node receives the query request, and the TEE service is called by the virtual machine of the encrypted contract (that is, the encrypted target data stored in the blockchain is decrypted by the virtual machine deployed in the TEE). The decrypted target data may be returned to the requester.

A communication connection is established between a light node 3 and a full node 6. The light node 3 initiates a query request, and the full node 6 broadcasts the query request in the blockchain, so that the endorsement node receives the query request of the light node 3. However the light node 3 is not authorized and fails to acquire the target data.

In this example, a logical operation of common data other than the target data may be performed through a common contract virtual machine deployed in the TEE. The common contract virtual machine may store the common data without encryption into the ledger.

In this example, an authorization node may be further deployed. The authorization node may be a creator of the encrypted smart contract and may authorize the node in the blockchain that may access the target data. The authorized node may include the full node and the light node.

Base on the same principle as the method shown in FIG. 1, FIG. 4 shows a schematic structural diagram of an apparatus of querying data provided by the embodiments of the present disclosure. As shown in FIG. 4, an apparatus 40 of querying data may include: a query request receiving module 410 used to receive a query request for target data stored in a blockchain, where the target data is encrypted by an encryption key in the TEE; and a decryption module 420 used to decrypt the target data in the TEE using a decryption key corresponding to the encryption key, and return the decrypted target data.

In the apparatus provided by the embodiments of the present disclosure, the query request for the target data encrypted and stored in the blockchain is received, the target data is decrypted in the TEE using the decryption key corresponding to the encryption key, and the decrypted target data is returned. Based on this solution, the query for the encrypted data stored in the blockchain may be achieved, so that a logical operation on the private data may be performed through the blockchain smart contract, and the availability of the blockchain smart contract may be improved.

Optionally, the encryption key is generated based on a root key stored in the TEE and a data identification of the target data, and when decrypting the target data in the TEE using the decryption key corresponding to the encryption key, the decryption module is specifically used to: generate the decryption key corresponding to the encryption key based on the root key and the data identification of the target data using the virtual machine deployed in the TEE, and decrypt the target data based on the decryption key.

Optionally, the data identification may include: a first identification of a smart contract the target data belongs to, and a second identification of the encryption key.

Optionally, when decrypting the target data in the TEE using the decryption key corresponding to the encryption key, the decryption module is specifically used to: determine whether the query request satisfies a preset access condition; and decrypt the target data in the TEE using the decryption key corresponding to the encryption key, in response to the query request satisfying the preset access condition.

Optionally, the access condition includes at least one of that a node initiating the query request has been authorized; or that a signature carried in the query request is verified.

It may be understood that the above-described modules of the apparatus of querying the data in the embodiments of the present disclosure have functions of performing corresponding steps in the method of querying the data in the embodiments shown in FIG. 1. The functions may be implemented by hardware or by executing corresponding software by hardware. The hardware or software includes one or more modules corresponding to the above functions. The above-described modules may be software and/or hardware. Each module may be implemented separately, or a plurality of modules may be integrated. For a description of the function of each module in the apparatus of querying the data, reference may be made to the corresponding description of the method of querying the data in the embodiments shown in FIG. 1, and details will not be repeated here.

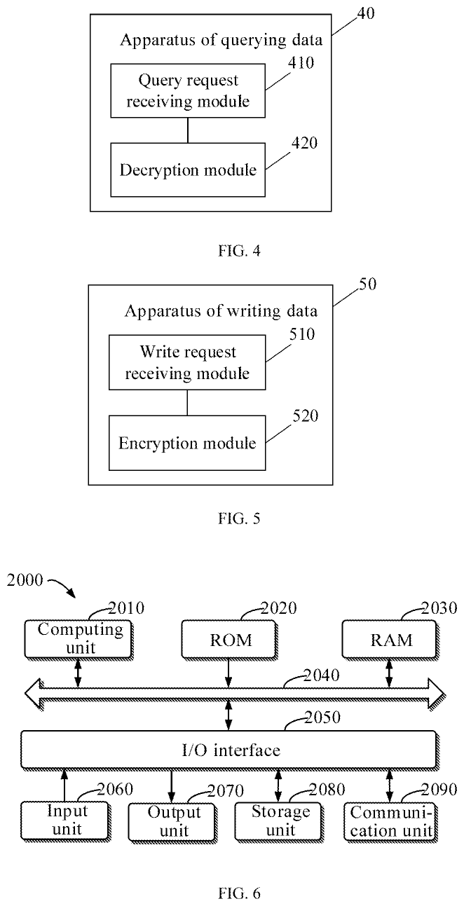

Base on the same principle as the method shown in FIG. 2, FIG. 5 shows a schematic structural diagram of an apparatus of writing data provided by the embodiments of the present disclosure. As shown in FIG. 5, an apparatus 50 of writing data may include: a write request receiving module 510 used to receive a write request to write target data into a blockchain- and an encryption module 520 used to encrypt the target data in the TEE using an encryption key, and return the encrypted target data.

In the apparatus provided by the embodiment of the present disclosure, the write request to write the target data into the blockchain is received, the target data is encrypted in the TEE using the encryption key, and the encrypted target data is returned. Based on this solution, the writing of the encrypted data stored on the blockchain may be achieved, so that a logical operation on the private data may be performed through the blockchain smart contract, and the availability of the blockchain smart contract may be improved.

Optionally, when encrypting the target data in the TEE using the encryption key, the encryption module is specifically used to: generate the encryption key based on a root key stored in the TEE and a data identification of the target data using a virtual machine deployed in the TEE, and encrypt the target data based on the encryption key.

Optionally, the data identification may include: a first identification of a smart contract the target data belongs to, and a second identification of the encryption key.

Optionally, when encrypting the target data in the TEE using the encryption key, the encryption module is specifically used to: determine whether the write request satisfies a preset write condition; and encrypt the target data in the TEE using the encryption key, in response to the write request satisfying the preset write condition.

Optionally, the write condition includes at least one of that a node initiating the write request has been authorized; or that a signature carried in the write request is verified.

It may be understood that the above-described modules of the apparatus of writing the data in the embodiments of the present disclosure have functions of performing corresponding steps in the method of writing the data in the embodiments shown in FIG. 2. The functions may be implemented by hardware or by executing corresponding software by hardware. The hardware or software includes one or more modules corresponding to the above functions. The above-described module may be software and/or hardware. Each module may be implemented separately, or a plurality of modules may be integrated. For a description of the function of each module in the apparatus of writing the data, reference may be made to the corresponding description of the method of writing the data in the embodiments shown in FIG. 2, and details will not be repeated here.

In the technical solution of the present disclosure, the collection, storage, use, processing, transmission, provision, disclosure, and application of user personal information involved comply with provisions of relevant laws and regulations, take essential confidentiality measures, and do not violate public order and good custom.

In the technical solution of the present disclosure, authorization or consent is obtained from the user before the use's personal information is obtained or collected.

According to the embodiments of the present disclosure, the present disclosure further provides an electronic device, a readable storage medium, and a computer program product.

The electronic device includes: at least one processor; and a memory communicatively connected to the at least one processor. The memory stores instructions executable by the at least one processor, and the instructions, when executed by the at least one processor, cause the at least one processor to implement the method provided by the embodiments of the present disclosure.

Compared with a related art, the electronic device may be implemented to receive the query request for the target data encrypted and stored in the blockchain, decrypt the target data in the TEE using the decryption key corresponding to the encryption key, and return the decrypted target data. Based on this solution, the query for the encrypted data stored in the blockchain may be achieved, so that a logical operation on the private data may be performed through the blockchain smart contract, and the availability of the blockchain smart contract may be improved.

The readable storage medium is a non-transitory computer readable storage medium having computer instructions stored thereon. The computer instructions are used to cause a computer to perform the method provided by the embodiments of the present disclosure.

Compared with the related art, the readable storage medium may be implemented to receive the query request for the target data encrypted and stored in the blockchain, decrypt the target data in the TEE using the decryption key corresponding to the encryption key, and return the decrypted target data. Based on this solution, the query for the encrypted data stored in the blockchain may be achieved, so that a logical operation on the private data may be performed through the blockchain smart contract, and the availability of the blockchain smart contract may be improved.

The computer program product contain a computer program. When executed by a processor, the computer program causes the processor to implement the method provided by the embodiments of the present disclosure.

Compared with the related art, the computer program product may be implemented to receive the query request for the target data encrypted and stored in the blockchain, decrypt the target data in the TEE using the decryption key corresponding to the encryption key, and return the decrypted target data. Based on this solution, the query for the encrypted data stored in the blockchain may be achieved, so that a logical operation on the private data may be performed through the blockchain smart contract, and the availability of the blockchain smart contract may be improved.

FIG. 6 shows a schematic block diagram of an exemplary electronic device 2000 for implementing the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 2000 may include a computing unit 2010, which may perform various appropriate actions and processing based on a computer program stored in a read-only memory (ROM) 2020 or a computer program loaded from a storage unit 2020 into a random access memory (RAM) 2030. Various programs and data required for the operation of the electronic device 2000 may be stored in the RAM 2030. The computing unit 2010, the ROM 2020 and the RAM 2030 are connected to each other through a bus 2040. An input/output (I/O) interface 2050 is further connected to the bus 2040.

Various components in the electronic device 2000, including an input unit 2060 such as a keyboard, a mouse, etc., an output unit 2070 such as various types of displays, speakers, etc., a storage unit 2080 such as a magnetic disk, an optical disk, etc., and a communication unit 2090 such a a network card, a modem, a wireless communication transceiver, etc., we connected to the I/O interface 2050. The communication unit 2090 allows the electronic device 2000 to exchange information/data with other devices through a computer network such as the Internet and/or various telecommunication networks.

The computing unit 2010 may be various general-purpose and/or special-purpose processing components with processing and computing capabilities. Some examples of the computing unit 2010 include but are not limited to a central processing unit (CPU), a graphics processing unit (OPU), various dedicated artificial intelligence (AI) computing chips, various computing units running machine learning model algorithms, a digital signal processor (DSP), and any appropriate processor, controller, microcontroller, and so on. The computing unit 2010 may perform the method provided by the embodiments of the present disclosure. For example, in some embodiments the method provided by the embodiments of the present disclosure may be implemented as a computer software program that is tangibly contained on a machine-readable medium, such as the storage unit 2080. In some embodiments, part or all of a computer program may be loaded and/or installed on the electronic device 2000 via the ROM 2020 and/or the communication unit 2090. When the computer program is loaded into the RAM 2030 and executed by the computing unit 2010, one or more steps of the method provided by the embodiments of the present disclosure may be performed. Alternatively, in other embodiments, the computing unit 2010 may be configured to perform the method provided by the embodiments of the present disclosure in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes we executed by the processor or the controller the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for me by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a serve. The client and the server are generally far away from each other and usually interact through a communication network. The relationship between the client and the server is generated through computer programs running on the corresponding computers and having a client-server relationship with each other. The server may be a cloud server. The server may also be a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the mope of protection of the present disclosure.

What is claimed is:

1. A method of querying data, comprising:
receiving a query request for target data stored in a blockchain, wherein the target data is encrypted by an encryption key in a trusted execution environment TEE; and
decrypting the target data in the TEE using a decryption key corresponding to the encryption key, and returning the decrypted target data.

2. The method of claim 1, wherein the encryption key is generated based on a root key stored In the TEE and a data identification of the target data, and the decrypting the target data in the TEE using a decryption key corresponding to the encryption key comprises:
generating the decryption key corresponding to the encryption key based on the root key and the data identification of the target data using a virtual machine deployed in the TEE, and decrypting the target data based on the decryption key.

3. The method of claim 2, wherein the data identification comprises: a first identification of a smart contract the target data belongs to, and a second identification of the encryption key.

4. The method of claim 1, wherein the decrypting the target data in the TEE using a decryption key corresponding to the encryption key comprises:
determining whether the query request satisfies a preset access condition; and
decrypting the target data in the TEE using the decryption key corresponding to the encryption key, in response to the query request satisfying the preset access condition.

5. The method of claim 4, wherein the access condition comprises at least one of that:
a node initiating the query request has been authorized; or
a signature carried in the query request is verified.

6. The method of claim 2, wherein the decrypting the target data in the TEE using a decryption key corresponding to the encryption key comprises:
determining whether the query request satisfies a preset access condition; and
decrypting the target data in the TEE using the decryption key corresponding to the encryption key, in response to the query request satisfying the preset access condition.

7. The method of claim 6, wherein the access condition comprises at least one of that:
a node initiating the query request has been authorized; or
a signature carried in the query request is verified.

8. The method of claim 3, wherein the decrypting the target data in the TEE using a decryption key corresponding to the encryption key comprises:
determining whether the query request satisfies a preset access condition; and
decrypting the target data in the TEE using the decryption key corresponding to the encryption key, in response to the query request satisfying the preset access condition.

9. The method of claim 8, wherein the access condition comprises at least one of that:
a node initiating the query request has been authorized; or
a signature carried in the query request is verified.

10. A method of writing data, comprising:
receiving a write request to write target data into a blockchain; and
encrypting the target data in a TEE using an encryption key, and returning the encrypted target data.

11. The method of claim 10, wherein the encrypting the target data in the TEE using an encryption key comprises:
generating the encryption key based on a root key stored in the TEE and a data identification of the target data using a virtual machine deployed in the TEE, and encrypting the target data based on the encryption key.

12. The method of claim 11, wherein the data identification comprises: a first identification of a smart contract the target data belongs to, and a second identification of the encryption key.

13. The method of claim 10, wherein the encrypting the target data in the TEE using an encryption key comprises:
determining whether the write request satisfies a preset write condition; and
encrypting the target data in the TEE using the encryption key, in response to the write request satisfying the preset write condition.

14. The method of claim 13, wherein the write condition comprises at least one of that:
a node initiating the write request has been authorized; or
a signature carried in the write request is verified.

15. The method of claim 11, wherein the encrypting the target data in the TEE using an encryption key comprises:
determining whether the write request satisfies a preset write condition; and
encrypting the target data in the TEE using the encryption key, in response to the write request satisfying the preset write condition.

16. The method of claim 12, wherein the encrypting the target data in the TEE using an encryption key comprises:
determining whether the write request satisfies a preset write condition; and
encrypting the target data in the TEE using the encryption key, in response to the write request satisfying the preset write condition.

17. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

18. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 10.

19. A non-transitory computer-readable storage medium having computer instructions stored thereon, wherein the computer instructions are configured to cause a computer to implement the method of claim 1.

20. A non-transitory computer-readable storage medium having computer instructions stored thereon, wherein the computer instructions are configured to cause a computer to implement the method of claim 10.
